(19) United States
(12) Patent Application Publication
(10) Pub. No.: US 2023/0311624 A1
(43) Pub. Date: Oct. 5, 2023

(54) VEHICLE DOOR STRUCTURE

(71) Applicant: Mazda Motor Corporation, Hiroshima (JP)

(72) Inventors: Yusuke NISHIMURA, Hiroshima (JP); Mitsuru KAKEYA, Hiroshima (JP); Masaki MOTODERA, Hiroshima (JP); Takahiro ISHITOMI, Hiroshima (JP); Atsushi YOSHII, Hiroshima (JP)

(73) Assignee: Mazda Motor Corporation, Hiroshima (JP)

(21) Appl. No.: 18/125,134

(22) Filed: Mar. 23, 2023

(30) Foreign Application Priority Data
Apr. 1, 2022 (JP) 2022-061937

(51) Int. Cl. B60J 5/04; B60J 1/17

(52) U.S. Cl. CPC B60J 5/0408; B60J 1/17; B60J 5/0422

(57) ABSTRACT

A vehicle door structure that suppresses a situation in which the door window detaches from the above-mentioned guide rail includes a front guide rail that holds a door window while allowing a raising and lowering operation of the door window, and a guide rail support portion that fixes the front guide rail to a door inner panel, wherein the guide rail support portion includes a first section that is fixed to a front face portion of a door inner panel, a second section that extends rearward from a vehicle-width-direction inner side of the first section, and a third section that is provided at a rear end portion of the second section and that is fixed to the front guide rail, and the second section and the third section are configured to be supported in a cantilever manner with respect to the first section.

### CROSS-REFERENCE TO RELATED APPLICATION

The present application claims priority to Japanese Patent Application No. 2022-061937 filed on Apr. 1, 2022, the entire contents of which are incorporated herein by reference.

### BACKGROUND

### Field

The present disclosure relates to a vehicle door structure in which a door window (so-called door window glass) that opens and closes a window opening is held by guide rails in such a way as to be capable of being raised and lowered.

### DESCRIPTION OF THE RELATED ART

In general, a door window is held by a pair of front and rear guide rails in such a way as to be capable of being raised and lowered, the pair of front and rear guide rails being provided to the inside of the door. When a door is closed with the door window in a fully open state (housed state), an input in the inward direction along the vehicle width direction is input into the guide rails holding the door window, so that the door window rebounds outward in the vehicle width direction as a reaction. There is a possibility that the door window displaces outward in the vehicle width direction due to such a rebound load, thus detaching from the guide rail.

To solve such a problem, conventionally, as disclosed in Patent Literature 1, guide rails and a door inner panel are connected with each other by a connecting member to suppress the displacement of the guide rails in the vehicle width direction by the above-mentioned connecting member when the door is closed, thus suppressing a situation in which the door window detaches from the guide rail.

However, in cases in which the size of a door and a door window increases, an input that is input into guide rails when the door is closed increases, thus causing a connecting member to be deflected and deformed, leading to an increase in the amount of rebound and hence, a problem occurs in which the door window detaches from the guide rail.

### CITATION LIST

### Patent Literature

[Patent Literature 1] Japanese Patent Laid-Open No. 2020-40445

### SUMMARY

### Problems to be Solved

In view of the above, it is an object of the present disclosure to provide a vehicle door structure in which a guide rail can be caused to follow a door window with respect to a vehicle-width-direction input that is input into the guide rail with the door window in a fully open state, thus suppressing a situation in which the door window detaches from the above-mentioned guide rail.

### Solutions to the Problems

The present disclosure is directed to a vehicle door structure characterized by including: a door inner panel that forms a surface of the vehicle door structure on a vehicle cabin inner side; a door window that opens and closes a window opening located above a beltline; a front guide rail that holds the door window while allowing a raising and lowering operation of the above-mentioned door window; and a guide rail support portion that fixes the above-mentioned front guide rail to the above-mentioned door inner panel, wherein the above-mentioned guide rail support portion includes a first section that is fixed to a front face portion of the above-mentioned door inner panel, a second section that extends rearward from a vehicle-width-direction inner side of the above-mentioned first section, and a third section that is provided at a rear end portion of the above-mentioned second section and that is fixed to the above-mentioned front guide rail, and the above-mentioned second section and the above-mentioned third section are configured to be supported in a cantilever manner with respect to the above-mentioned first section.

The above-described guide rail support portion may be formed by a hinge reinforcement.

With the present disclosure, the second section and the third section of the guide rail support portion are caused to be in a cantilever state with respect to the first section fixed to the front face portion of the door inner panel, thus allowing the second section to be deflected and deformed with respect to a vehicle-width-direction input that is input into the front guide rail with the door window in a fully open state, and the front guide rail can thus be caused to follow the door window. Therefore, it is possible to suppress a situation in which the door window detaches from the front guide rail.

The present disclosure is also directed to a vehicle door structure characterized by including: a door inner panel that forms a surface of the vehicle door structure on a vehicle cabin inner side; a door window that opens and closes a window opening located above a beltline; a front guide rail that holds the door window while allowing a raising and lowering operation of the above-mentioned door window; and a guide rail support portion that fixes the above-mentioned front guide rail to the above-mentioned door inner panel, wherein the above-mentioned guide rail support portion includes a first section that is fixed to a front face portion of the above-mentioned door inner panel, a second section that extends rearward from a vehicle-width-direction inner side of the above-mentioned first section, and a third section that is provided at a rear end portion of the above-mentioned second section and that is fixed to the above-mentioned front guide rail, and the above-mentioned second section is configured to be capable of being deflected and deformed in a vehicle width direction.

With the present disclosure, the second section of the guide rail support portion is capable of being deflected and deformed in the vehicle width direction relative to the first section fixed to the front face portion of the door inner panel, thus allowing the second section to be deflected and deformed with respect to a vehicle-width-direction input that is input into the front guide rail with the door window in a fully open state, and the front guide rail can thus be caused to follow the door window. Therefore, it is possible to suppress a situation in which the door window detaches from the front guide rail.

As an aspect of the present disclosure, the above-mentioned first section may be located at a door hinge fixation portion.

With the present disclosure, the first section is located at the door hinge fixation portion and hence, the guide rail support portion can be formed by the hinge reinforcement. Accordingly, the front guide rail can be supported by the guide rail support portion, formed by the hinge reinforcement, without providing another member for supporting the front guide rail.

That is, with the guide rail support portion, it is possible to achieve both support of the front guide rail, which has a function of suppressing detachment of the door window, and reinforcement of a door hinge portion.

As an aspect of the present disclosure, the above-mentioned third section may be disposed in such a way as to overlap with an impact bar when viewed from a side of a vehicle.

With the present disclosure, when a vehicle has a side collision, the impact bar comes into contact with the front guide rail and the third section of guide rail support portion and hence, it is possible to suppress concentration of stress on a joined portion located at the front end portion of the above-mentioned impact bar and joined to the door inner panel.

In other words, when a vehicle has a side collision, the above-mentioned impact bar bends and deforms, thus absorbing side collision energy. Therefore, the impact bar has a function of suppressing the deformation of the door, and a function of transmitting a side collision load to the hinge pillar of the vehicle body from the joined portion, located at the front end portion of the impact bar and joined to the door inner panel, thus transmitting the side collision load to the vehicle body via the hinge pillar.

In the case in which a side collision load is excessively large, the impact bar bends excessively, thus causing the above-mentioned joined portion located at the front end portion of the impact bar to separate. However, the third section overlaps with the impact bar when viewed from the side and hence, at the time of a side collision, the impact bar bends and comes into contact with the fixation portion, at which the front guide rail and the third section are fixed with each other, thus dispersing stress. Accordingly, it is possible to suppress a situation in which stress concentrates on the above-mentioned joined portion located at the front end portion of the impact bar.

As an aspect of the present disclosure, the above-mentioned third section may be fixed to a front face portion of the above-mentioned front guide rail.

With the present disclosure, a vehicle-width-direction input that is input into the front guide rail can be received by a shear surface and hence, it is possible to increase strength.

As an aspect of the present disclosure, the above-mentioned third section may be fixed to an inner-side face portion or an outer-side face portion of the above-mentioned front guide rail.

With the present disclosure, when a vehicle-width-direction load is input into the front guide rail, it is possible to smoothly transmit the vehicle-width-direction load to the above-mentioned second section.

As an aspect of the present disclosure, the above-mentioned second section may be configured to have a flat surface.

With the present disclosure, the above-mentioned second section configured to have a flat surface in order not to increase rigidity is allowed to be deflected and deformed when a vehicle-width-direction load is input and hence, deflection and deformation occurs easily. As a result, it is possible to increase followability of the front guide rail with respect to the door window and hence, it is possible to further suppress a situation in which the door window detaches from the front guide rail.

As an aspect of the present disclosure, a lower portion of the above-mentioned front guide rail may be joined only to the above-mentioned guide rail support portion.

With the present disclosure, the lower portion of the front guide rail has a cantilever structure and hence, when a vehicle-width-direction load is input with the door window in a fully open state, it is possible to cause the front guide rail to surely follow the door window.

### Advantages

According to the present disclosure, it is possible to obtain an advantageous effect in which the guide rail can be caused to follow the door window with respect to a vehicle-width-direction input that is input into the guide rail with the door window in a fully open state, thus suppressing a situation in which the door window detaches from the above-mentioned guide rail.

### BRIEF DESCRIPTION OF DRAWINGS

FIG. 1 is an outer side view showing a vehicle door structure.

FIG. 2 is a side view of the vehicle door structure with a door outer panel removed from FIG. 1.

FIG. 3 is an enlarged side view of a main part of FIG. 2 with a beltline reinforcement outer and an impact bar removed from FIG. 2.

FIG. 4 is a perspective view of a main part with a door window in a fully open state.

FIG. 5 is an enlarged cross-sectional view of the main part taken along line A-A in FIG. 2.

FIG. 6 is an enlarged cross-sectional view of the main part taken along line B-B in FIG. 2.

### DETAILED DESCRIPTION

An object of the disclosed subject matter is to cause a guide rail to follow a door window with respect to a vehicle-width-direction input that is input into the guide rail with a door window in a fully open state, thus suppressing a situation in which the door window detaches from the above-mentioned guide rail, and the object is achieved by a structure including:

a door inner panel that forms a surface of a vehicle door structure on a vehicle cabin inner side;

a door window that opens and closes a window opening located above a beltline;

a front guide rail that holds the door window while allowing a raising and lowering operation of the above-mentioned door window; and
a guide rail support portion that fixes the above-mentioned front guide rail to the above-mentioned door inner panel, wherein
the above-mentioned guide rail support portion includes
   a first section that is fixed to a front face portion of the above-mentioned door inner panel,
   a second section that extends rearward from a vehicle-width-direction inner side of the above-mentioned first section, and
   a third section that is provided at a rear end portion of the above-mentioned second section and that is fixed to the above-mentioned front guide rail, and
the above-mentioned second section and the above-mentioned third section are configured to be supported in a cantilever manner with respect to the above-mentioned first section.

### Embodiment

An embodiment of the present disclosure will be described hereinafter in detail with reference to drawings.

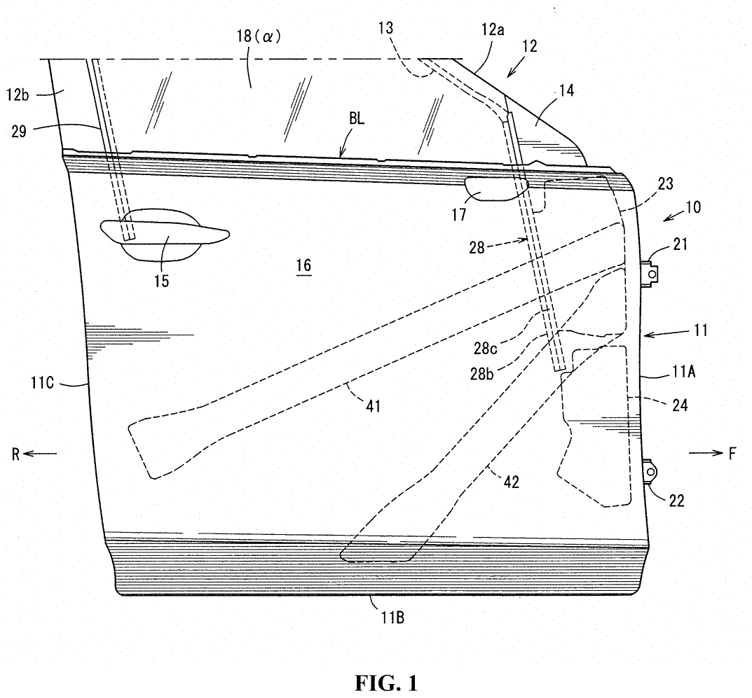

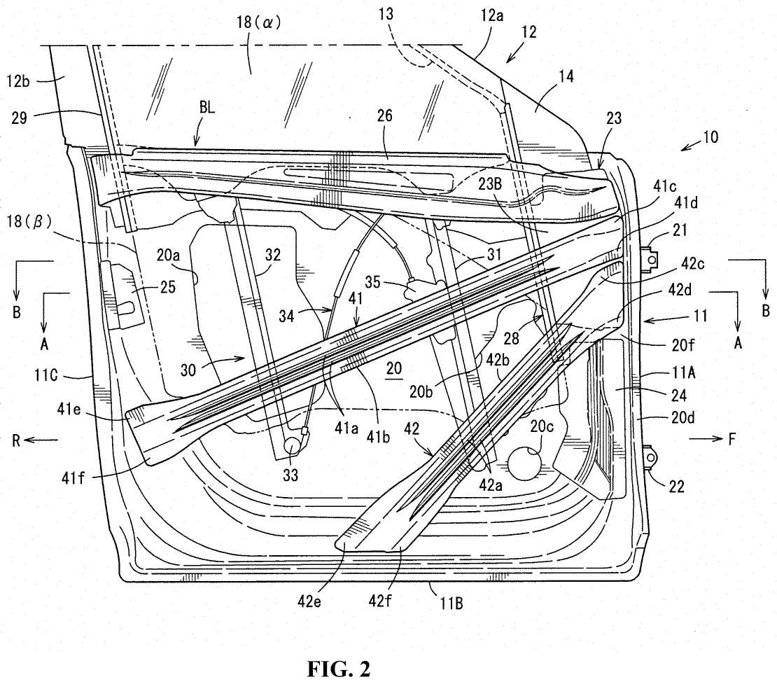

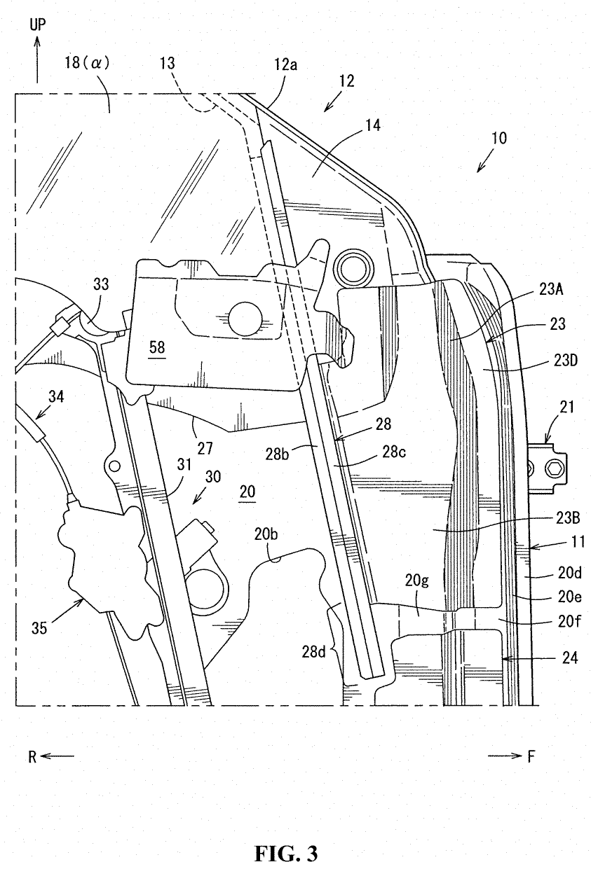

The drawings show a vehicle door structure, wherein FIG. 1 is an outer side view showing the vehicle door structure, FIG. 2 is a side view of the vehicle door structure with a door outer panel removed from FIG. 1, and FIG. 3 is an enlarged side view of a main part in FIG. 2 with a beltline reinforcement outer and an impact bar removed from FIG. 2.

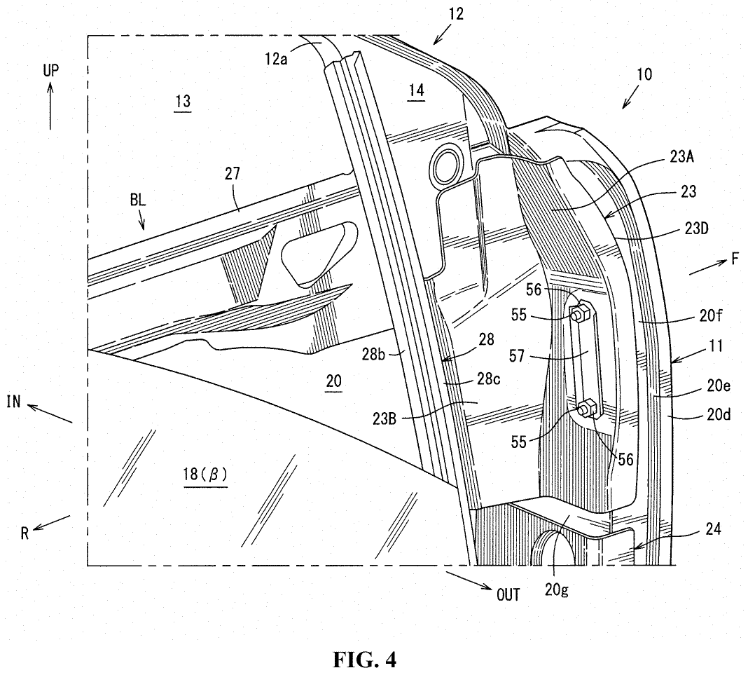

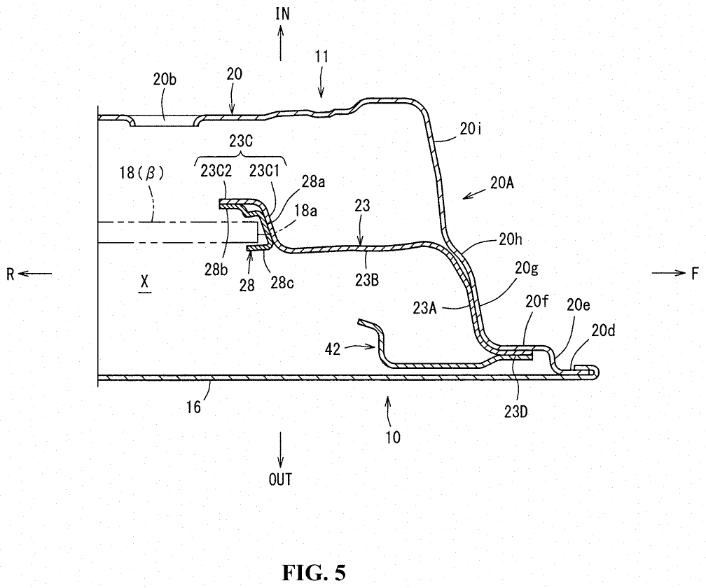

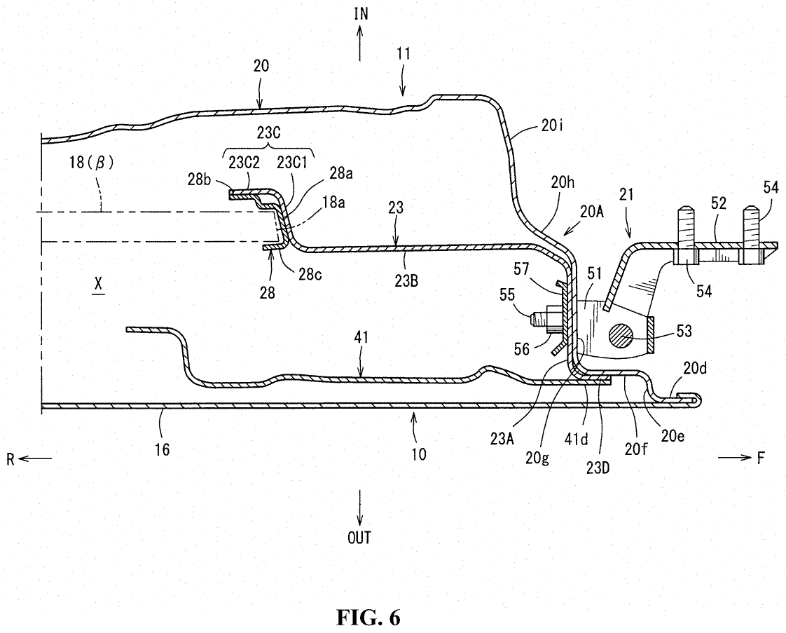

Further, FIG. 4 is a perspective view of a main part with a door window in a fully open state, FIG. 5 is an enlarged cross-sectional view of the main part taken along line A-A in FIG. 2, and FIG. 6 is an enlarged cross-sectional view of the main part taken along line B-B in FIG. 2.

As shown in FIG. 1 and FIG. 2, a door 10 (front door) is provided that opens and closes a door opening of a body.

Although only the door 10 on the right side of a vehicle is shown in the embodiment shown in the drawing, a door on the left side of the vehicle is configured to be bilaterally symmetric with the door 10 on the right side of the vehicle.

In this embodiment, the above-described door opening of the body is an opening surrounded by a hinge pillar, a side sill, a front pillar, a roof side rail, and a center pillar, the hinge pillar extending in the up-down direction on the front side of the side portion of a vehicle body, the side sill extending in the vehicle front-rear direction on the lower side of the side portion of the vehicle body, the front pillar extending in the rearward and upward direction from the upper end of the hinge pillar, the roof side rail extending rearward from the rear end of the front pillar, the center pillar connecting the roof side rail and the side sill in the up-down direction at an intermediate portion in the vehicle front-rear direction.

The above-described door 10 includes a door body 11 and a door sash portion 12. The door sash portion 12 includes a front sash portion 12a and a rear sash portion 12b, the front sash portion 12a extending in the rearward and upward direction along the front pillar and the roof side rail from the front portion of a beltline BL, which is disposed at the upper end of the door body 11, the rear sash portion 12b extending in the up-down direction along the center pillar from the rear end of the front sash portion 12a.

A space surrounded by the front sash portion 12a and the rear sash portion 12b of the above-described door sash portion 12 and the beltline BL is set as a window opening 13. A corner bracket 14 is provided at a corner portion formed between the front lower portion of the above-described front sash portion 12a and the front portion of the beltline BL.

As shown in FIG. 1, the above-described door body 11 includes a door outer handle 15, a door mirror, and a door window glass 18, the door outer handle 15 being provided at the rear portion of the door body 11, the door mirror being brought into contact with the outer surface of a door outer panel 16 in the vehicle width direction via a door mirror attachment portion 17, which is provided at the front side portion of the door outer panel 16 in the vicinity of the beltline BL, the door window glass 18 opening and closing the window opening 13 located above the beltline BL.

Note that, in the drawing, a fully closed state of the door window glass 18 is indicated by “α”, and a fully open state, that is, a housed state, of the door window glass 18 is indicated by “β”.

As shown in FIG. 2, the above-described door body 11 is formed by connecting a door inner panel 20 and the door outer panel 16, shown in FIG. 1, by hemming or the like, the door inner panel 20 forming the surface on the vehicle cabin inner side. The door body 11 includes a front side portion 11A, a lower side portion 11B, and a rear side portion 11C, a door hinge bracket upper portion 21 and a door hinge bracket lower portion 22 being attached to the front side portion 11A.

The above-described door inner panel 20 has a plurality of openings 20a, 20b, 20c.

Further, an upper hinge reinforcement 23 and a lower hinge reinforcement 24, each serving as a guide rail support portion, are joined and fixed to the door-inner-space-X side of the door inner panel 20 at the above-described front side portion 11A (see FIG. 5, FIG. 6). A latch reinforcement 25 is joined and fixed to the door-inner-space-X side of the door inner panel 20 at the above-described rear side portion 11C.

The above-described upper hinge reinforcement 23 is a reinforcement member provided for increasing support rigidity of the door hinge bracket upper portion 21, and this upper hinge reinforcement 23 is formed of an ultrahigh tensile strength steel sheet, for example. The above-described lower hinge reinforcement 24 is a reinforcement member provided for increasing support rigidity of the door hinge bracket lower portion 22. Further, the above-described latch reinforcement 25 is a reinforcement member provided for increasing support rigidity of a latch.

A beltline reinforcement outer 26 (see FIG. 2) and a beltline reinforcement inner 27 (see FIG. 4) extending in the vehicle front-rear direction are provided along the beltline BL. The beltline reinforcement outer 26 and the beltline reinforcement inner 27 are members that reinforce the edge portion of the entrance/exit for the door window glass 18. Particularly, the beltline reinforcement outer 26 is a reinforcement that reinforces the upper edge portion of the door outer panel 16.

As shown in FIG. 5 and FIG. 6, a front side portion 18a of the above-described door window glass 18 is configured such that raising/lowering of the front side portion 18a is guided by a front guide rail 28 provided in the door inner space X of the door body 11.

The above-described front guide rail 28 is a guide rail that holds the door window glass 18 while allowing a raising and lowering operation of the door window glass 18.

As shown in FIG. 5 and FIG. 6, the front guide rail 28 includes a front face portion 28a, an inner-side face portion 28b, and an outer-side face portion 28c, thus being formed into a squared U shape in cross section open toward the rearward side of the vehicle, the front face portion 28a extending in the vehicle width direction, the inner-side face portion 28b extending in the front-rear direction on the vehicle-width-direction inner side, the outer-side face portion 28c extending in the front-rear direction on the vehicle-width-direction outer side.

The lower major portion of the above-described front guide rail 28 is located at a position lower than the beltline BL, and a portion of the upper portion of the front guide rail 28 is located at a position higher than the beltline BL.

The portion of the above-mentioned front guide rail 28 disposed at the position lower than the beltline BL is fixed to the door inner panel 20 via the upper hinge reinforcement 23 serving as a guide rail support portion, and the portion of the front guide rail 28 disposed at the position higher than the beltline BL is fixed to the front sash portion 12a of the door sash portion 12.

In contrast, the rear side portion of the door window glass 18 is configured such that raising/lowering of the rear side portion of the door window glass 18 is guided by a rear guide rail 29. This rear guide rail 29 is a guide rail that holds the door window glass 18 while allowing the raising and lowering operation of the door window glass 18.

The upper major portion of the above-described rear guide rail 29 is located at a position higher than the beltline BL, and a portion of the lower portion of the rear guide rail 29 is located at a position lower than the beltline BL.

The portion of the above-mentioned rear guide rail 29 disposed at the position higher than the beltline BL is fixed to the rear sash portion 12b of the door sash portion 12, and the portion of the rear guide rail 29 disposed at the position lower than the beltline BL is fixed to the rear side portion 11C of the door body 11.

The above-described door window glass 18 is driven for raising and lowering by a window regulator 30 shown in FIG. 2 and FIG. 3.

As shown in FIG. 2 and FIG. 3, the window regulator 30 includes a pair of front and rear guide rails 31, 32, a carrier plate, winding portions 33 (for example, the window regulator 30 can include four total winding portions), a guide wire 34, and an actuator 35, the carrier plate sliding along the pair of guide rails 31, 32, the door window glass 18 being attached to and supported by the carrier plate, the winding portions 33 being provided to both upper and lower end portions of the pair of both guide rails 31, 32, the guide wire 34 extending orthogonally between the respective winding portions 33, the direction of the guide wire 34 being changed at the winding portions 33, the actuator 35 driving the guide wire 34.

The door window glass 18 is configured to be raised and lowered between the fully closed state a, shown by a solid line in FIG. 2, and the fully open state β, shown by an imaginary line in FIG. 2, by the driving of the above-mentioned actuator 35.

In the door body 11 including the above-described door outer panel 16 (see FIG. 1) and the above-described door inner panel 20 (see FIG. 2), two impact bars 41, 42 are provided between the front side portion 11A and the rear side portion 11C or the lower side portion 11B in a slant state, the two impact bars 41, 42 extending in the vehicle front-rear direction and being spaced apart from each other in the up-down direction.

The upper impact bar 41 is a member obtained by integrally forming an impact bar body 41b and flange portions 41c, 41d, 41e, 41f by a steel sheet, the impact bar body 41b including a plurality of (two in this embodiment) beads 41a, 41a extending in the front-rear direction, the flange portions 41c, 41d, 41e, 41f being integrally formed with both front and rear end portions of the impact bar body 41b.

The flange portions 41e, 41f, located at the rear end portion of the impact bar body 41b, are integrally formed with the impact bar body 41b in such a way as to increase the width of the impact bar body 41b in the up-down direction.

The flange portions 41c, 41d, located at the front side of the impact bar 41, are integrally joined to the intermediate portion of the upper hinge reinforcement 23 in the up-down direction, and the flange portions 41e, 41f, located at the rear side of the impact bar 41, are integrally joined to the door inner panel 20 at a position close to the rear side portion 11C. The impact bar 41 is disposed in a state of being inclined rearward such that the rear end of the impact bar 41 is located at a position lower than the front end of the impact bar 41, and the impact bar 41 is located at a position lower than the beltline BL and the beltline reinforcement outer 26.

The lower impact bar 42 is a member obtained by integrally forming an impact bar body 42b and flange portions 42c, 42d, 42e, 42f by a steel sheet, the impact bar body 42b including a plurality of (two in this embodiment) beads 42a, 42a extending in the front-rear direction, the flange portions 42c, 42d, 42e, 42f being integrally formed with both front and rear end portions of the impact bar body 42b to increase the width of the impact bar body 42b in the up-down direction and the width of the impact bar body 42b in the front-rear direction.

The flange portions 42c, 42d, located at the front side, are integrally joined to the lower portion of the upper hinge reinforcement 23 in the up-down direction, and the flange portions 42e, 42f, located at the rear side, are integrally joined to the door inner panel 20 at a position close to the lower side portion 11B, where the impact bar 42 is disposed in a state of being inclined rearward such that the rear end of the impact bar 42 is located at a position lower than the front end of the impact bar 42.

The lower impact bar 42 is located at a position lower than the upper impact bar 41. A configuration is adopted where a separation distance between the upper and lower impact bars 41, 42 on the rear end side is set to be larger than a separation distance between the upper and lower impact bars 41, 42 on the front end side to efficiently receive a side collision load by the two impact bars 41, 42.

In this embodiment, the above-described upper hinge reinforcement 23 is a reinforcement member that reinforces a portion at which the door hinge bracket upper portion 21 is disposed and that connects the front end portion of the beltline reinforcement outer 26, the front end portion of the upper impact bar 41, and the front end portion of the lower impact bar 42 in the up-down direction.

As shown in FIG. 6, the above-described door hinge bracket upper portion 21 includes a door-side hinge bracket 51, a body-side hinge bracket 52, and a hinge pin 53 that pivots both hinge brackets 51, 52. The body-side hinge bracket 52 is fixed to the hinge pillar by a plurality of bolts 54, serving as fastening members.

By fastening a nut 56, serving as a fastening member, to a bolt 55 of the bracket, the door-side hinge bracket 51 is integrally fastened to three members, that is, the door inner panel 20, the upper hinge reinforcement 23, and a plate 57.

In FIG. 3, “58” denotes a mirror reinforcement that is disposed at a position corresponding to the door mirror attachment portion 17 shown in FIG. 1.

As shown in FIG. 5 and FIG. 6, a front face portion 20A of the door inner panel 20 includes a front end flange portion 20d, an outer raised wall 20e, a stepped-down portion 20f, a front wall 20g, an inclined wall 20h, and an inner raised wall 20i, the outer raised wall 20e extending inward in the vehicle width direction from the rear end of the front end flange portion 20d, the stepped-down portion 20f extending rearward from the vehicle-width-direction inner end of the outer raised wall 20e, the front wall 20g extending inward in the vehicle width direction from the rear end of the stepped-down portion 20f, the inclined wall 20h extending more rearward as going away from the vehicle-width-direction inner end of the front wall 20g in the inward direction, the inner raised wall 20i extending inward in the vehicle width direction from the vehicle-width-direction inner end of the inclined wall 20h.

The upper hinge reinforcement 23 serves as a guide rail support portion that fixes the above-described front guide rail 28 to the door inner panel 20, and the upper hinge reinforcement 23 is configured as follows.

That is, as shown in FIG. 5 and FIG. 6, the upper hinge reinforcement 23 includes a first section 23A, a second section 23B, and a third section 23C, the first section 23A being fixed to the front wall 20g of the front face portion 20A of the door inner panel 20, the second section 23B extending rearward from the vehicle-width-direction inner side of the first section 23A, the third section 23C being provided at the rear end portion of the second section 23B and fixed to the front guide rail 28.

The above-described upper hinge reinforcement 23 also includes a fourth section 23D extending frontward from the vehicle-width-direction outer side of the first section 23A. The fourth section 23D is fixed to the stepped-down portion 20f of the door inner panel 20 together with the flange portions 41c, 41d of the impact bar 41 by three-piece welding.

Further, the above-described second section 23B and the third section 23C are configured to be supported in a cantilever manner with respect to the first section 23A. In other words, the second section 23B is configured to be capable of being deflected and deformed in the vehicle width direction.

As described above, the second section 23B and the third section 23C of the upper hinge reinforcement 23, serving as the guide rail support portion, are caused to be in a cantilever state with respect to the first section 23A fixed to the front face portion 20A of the door inner panel 20, thus allowing the second section 23B to be deflected and deformed with respect to a vehicle-width-direction input that is input into the front guide rail 28 with the door window glass 18 in a fully open state.

Therefore, a configuration is adopted in which the front guide rail 28 is caused to follow the displacement of the door window glass 18 in the vehicle width direction in order to suppress a situation in which the door window glass 18 detaches from the front guide rail 28.

Further, the above-described second section 23B and the third section 23C are configured to be capable of being deflected and deformed in the vehicle width direction relative to the first section 23A, thus allowing the second section 23B and the third section 23C to be deflected and deformed in the vehicle width direction with respect to a vehicle-width-direction input that is input into the front guide rail 28 with the door window glass 18 in a fully open state (that is, a housed state).

Therefore, a configuration is adopted in which the front guide rail 28 is caused to follow the displacement of the door window glass 18 in the vehicle width direction, thus suppressing a situation in which the door window glass 18 detaches from the front guide rail 28.

Further, the first section 23A of the upper hinge reinforcement 23 is located at a door hinge fixation portion, that is, at the fixation portion of the door-side hinge bracket 51 of the door hinge bracket upper portion 21.

As described above, the first section 23A is located at the above-described door hinge fixation portion and hence, the guide rail support portion can be formed by the upper hinge reinforcement 23, and the front guide rail 28 is supported by the guide rail support portion, formed by the upper hinge reinforcement 23, without providing another member for supporting the front guide rail 28.

That is, a configuration is adopted in which, with the above-mentioned guide rail support portion, it is possible to achieve both support of the front guide rail 28, which has a function of suppressing detachment of the door window glass 18, and reinforcement of a door hinge portion.

Further, as shown in FIG. 2 and FIG. 6, the third section 23C of the upper hinge reinforcement 23 is disposed in such a way as to overlap with the upper impact bar 41 when viewed from the side of the vehicle.

Therefore, a configuration is adopted in which when the vehicle has a side collision, the impact bar 41 comes into contact with the front guide rail 28 and the third section 23C of the upper hinge reinforcement 23, thus suppressing concentration of stress on joined portions (see the flange portions 41c, 41d) located at the front end portion of the impact bar 41 and joined to the door inner panel 20.

To be specific, when a vehicle has a side collision, the above-mentioned impact bar 41 bends and deforms, thus absorbing side collision energy. Therefore, the impact bar 41 has a function of suppressing the deformation of the door 10, and a function of transmitting a side collision load to the hinge pillar of the vehicle body from the joined portions, located at the front end portion of the impact bar 41 and joined to the door inner panel 20, thus transmitting the side collision load to the vehicle body via the hinge pillar.

In the case in which a side collision load is excessively large, the impact bar 41 bends excessively, thus causing the above-mentioned joined portion located at the front end portion of the impact bar 41 to separate. However, the above-mentioned third section 23C overlaps with the impact bar 41 when viewed from the side and hence, at the time of a side collision, the impact bar 41 bends and comes into contact with the fixation portion, at which the front guide rail 28 and the third section 23C are fixed with each other, thus dispersing stress. Therefore, a configuration is adopted in which it is possible to suppress a situation in which stress concentrates on the above-mentioned joined portion located at the front end portion of the impact bar 41.

As shown in FIG. 5 and FIG. 6, the third section 23C of the upper hinge reinforcement 23 includes a front wall 23C1 and an inner wall 23C2, the front wall 23C1 extending inward in the vehicle width direction from the rear end of the second section 23B, the inner wall 23C2 extending rearward from the vehicle-width-direction inner end of the front wall 23C1.

As shown in FIG. 5 and FIG. 6, the front wall 23C1 of the above-mentioned third section 23C is fixed to the front face portion 28a of the front guide rail 28. Therefore, a configuration is adopted in which a vehicle-width-direction input that is input into the front guide rail 28 is received by a shear surface and hence, strength can be increased.

As shown in FIG. 5 and FIG. 6, the inner wall 23C2 of the above-mentioned third section 23C is fixed to the inner-side face portion 28b of the front guide rail 28. Therefore, a configuration is adopted in which when a vehicle-width-direction load is input into the front guide rail 28, the vehicle-width-direction load can be smoothly transmitted to the above-described second section 23B.

As shown in FIG. 3 and FIG. 4, the above-described second section 23B, particularly, the lower major portion of the second section 23B is configured to have a flat surface.

As described above, the second section 23B configured to have a flat surface in order not to increase rigidity is allowed to be deflected and deformed when a vehicle-width-direction load is input and hence, deflection and deformation occurs easily. As a result, a configuration is adopted in which followability of the front guide rail 28 with respect to the door window glass 18 is increased, so that detachment of the door window glass 18 from the front guide rail 28 is further suppressed.

As shown in FIG. 3, while the upper portion of the front guide rail 28 is joined to the corner bracket 14, the lower portion of the front guide rail 28 is joined only to the upper hinge reinforcement 23, serving as the guide rail support portion, and a lower end portion 28d of the front guide rail 28 is set as a non-joined portion, which is not joined to any member.

As described above, a configuration is adopted in which the lower portion of the front guide rail 28 is joined only to the upper hinge reinforcement 23, thus having a cantilever structure and hence, the front guide rail 28 is caused to surely follow the door window glass 18 when a vehicle-width-direction load is input with the door window glass 18 in a fully open state.

In the drawing, an arrow F denotes a vehicle forward direction, an arrow R denotes a vehicle rearward direction, an arrow IN denotes an inward direction along the vehicle width direction, an arrow OUT denotes an outward direction along the vehicle width direction, and an arrow UP denotes a vehicle upward direction.

As described above, the vehicle door structure according to the present embodiment is characterized by including: the door inner panel 20 that forms the surface of the vehicle door structure on a vehicle cabin inner side; the door window glass 18 that opens and closes the window opening 13 located above the beltline BL; the front guide rail 28 that holds the door window glass 18 while allowing a raising and lowering operation of the above-mentioned door window glass 18, and the guide rail support portion (upper hinge reinforcement 23) that fixes the above-mentioned front guide rail 28 to the above-mentioned door inner panel 20, wherein the above-mentioned guide rail support portion (upper hinge reinforcement 23) includes the first section 23A that is fixed to the front face portion 20A of the above-mentioned door inner panel 20, the second section 23B that extends rearward from the vehicle-width-direction inner side of the above-mentioned first section 23A, and the third section 23C that is provided at the rear end portion of the above-mentioned second section 23B and that is fixed to the above-mentioned front guide rail 28, and the above-mentioned second section 23B and the above-mentioned third section 23C are configured to be supported in a cantilever manner with respect to the above-mentioned first section 23A (see FIG. 2, FIG. 5, FIG. 6).

According to such a vehicle door structure, the second section 23B and the third section 23C of the guide rail support portion (upper hinge reinforcement 23) are caused to be in a cantilever state with respect to the first section 23A fixed to the front face portion 20A of the door inner panel 20, thus allowing the second section 23B to be deflected and deformed with respect to a vehicle-width-direction input that is input into the front guide rail 28 with the door window glass 18 in a fully open state, and the front guide rail 28 can thus be caused to follow the door window glass 18. Therefore, it is possible to suppress a situation in which the door window glass 18 detaches from the front guide rail 28.

The vehicle door structure according to the present embodiment is also characterized by including: the door inner panel 20 that forms the surface of the vehicle door structure on a vehicle cabin inner side; the door window glass 18 that opens and closes the window opening 13 located above the beltline BL; the front guide rail 28 that holds the door window glass 18 while allowing a raising and lowering operation of the above-mentioned door window glass 18; and the guide rail support portion (upper hinge reinforcement 23) that fixes the above-mentioned front guide rail 28 to the above-mentioned door inner panel 20, wherein the above-mentioned guide rail support portion (upper hinge reinforcement 23) includes the first section 23A that is fixed to the front face portion 20A of the above-mentioned door inner panel 20, the second section 23B that extends rearward from the vehicle-width-direction inner side of the above-mentioned first section 23A, and the third section 23C that is provided at the rear end portion of the above-mentioned second section 23B and that is fixed to the above-mentioned front guide rail 28, and the above-mentioned second section 23B is configured to be capable of being deflected and deformed in the vehicle width direction (see FIG. 2, FIG. 5, FIG. 6).

According to such a vehicle door structure, the second section 23B of the guide rail support portion (upper hinge reinforcement 23) is capable of being deflected and deformed in the vehicle width direction relative to the first section 23A fixed to the front face portion 20A of the door inner panel 20, thus allowing the second section 23B to be deflected and deformed with respect to a vehicle-width-direction input that is input into the front guide rail 28 with the door window glass 18 in a fully open state, and the front guide rail 28 can thus be caused to follow the door window glass 18. Therefore, it is possible to suppress a situation in which the door window glass 18 detaches from the front guide rail 28.

Further, in such a vehicle door structure, the above-mentioned first section 23A is located at the door hinge fixation portion (see the portion at which the door-side hinge bracket 51 of the door hinge bracket upper portion 21 is fixed) (see FIG. 6).

According to such a vehicle door structure, the first section 23A is located at the door hinge fixation portion and hence, the guide rail support portion can be formed by the hinge reinforcement (upper hinge reinforcement 23). Accordingly, the front guide rail 28 can be supported by the guide rail support portion, formed by the hinge reinforcement (upper hinge reinforcement 23), without providing another member for supporting the front guide rail 28.

That is, with the guide rail support portion, it is possible to achieve both support of the front guide rail 28, which has a function of suppressing detachment of the door window glass 18, and reinforcement of the door hinge portion.

Further, in such a vehicle door structure, the above-mentioned third section 23C is disposed in such a way as to overlap with the impact bar 41 when viewed from the side of the vehicle (see FIG. 2, FIG. 6).

According to such a vehicle door structure, when a vehicle has a side collision, the impact bar 41 comes into contact with the front guide rail 28 and the third section 23C of the guide rail support portion (upper hinge reinforcement 23) and hence, it is possible to suppress concentration of stress on the joined portions (see the flange portions 41c, 41d) located at the front end portion of the above-mentioned impact bar 41 and joined to the door inner panel 20.

To be specific, when a vehicle has a side collision, the above-mentioned impact bar 41 bends and deforms, thus absorbing side collision energy. Therefore, the impact bar 41 has a function of suppressing the deformation of the door 10, and a function of transmitting a side collision load to the hinge pillar of the vehicle body from the joined portions, located at the front end portion of the impact bar 41 and joined to the door inner panel 20, thus transmitting the side collision load to the vehicle body via the hinge pillar.

In the case in which a side collision load is excessively large, the impact bar 41 bends excessively, thus causing the above-mentioned joined portion located at the front end portion of the impact bar 41 to separate. However, the third section 23C overlaps with the impact bar 41 when viewed from the side and hence, at the time of a side collision, the impact bar 41 bends and comes into contact with the fixation portion, at which the front guide rail 28 and the third section 23C are fixed with each other, thus dispersing stress. Accordingly, it is possible to suppress a situation in which stress concentrates on the above-mentioned joined portion located at the front end portion of the impact bar 41.

Still further, in such a vehicle door structure, the above-mentioned third section 23C is fixed to the front face portion 28a of the above-mentioned front guide rail 28 (see FIG. 5, FIG. 6).

According to such a vehicle door structure, a vehicle-width-direction input that is input into the front guide rail 28 can be received by a shear surface and hence, it is possible to increase strength.

In addition to the above, in such a vehicle door structure, the above-mentioned third section 23C is fixed to the inner-side face portion 28b or the outer-side face portion 28c of the above-mentioned front guide rail 28 (the inner-side face portion 28b in the above-mentioned embodiment) (see FIG. 5, FIG. 6).

According to such a vehicle door structure, when a vehicle-width-direction load is input into the front guide rail 28, it is possible to smoothly transmit the vehicle-width-direction load to the above-mentioned second section 23B.

Further, in such a vehicle door structure, the above-mentioned second section 23B is configured to have a flat surface (see FIG. 3, FIG. 4).

According to such a vehicle door structure, the above-mentioned second section 23B configured to have a flat surface in order not to increase rigidity is allowed to be deflected and deformed when a vehicle-width-direction load is input and hence, deflection and deformation occurs easily. As a result, it is possible to increase followability of the front guide rail 28 with respect to the door window glass 18 and hence, it is possible to further suppress a situation in which the door window glass 18 detaches from the front guide rail 28.

Further, in such a vehicle door structure, the lower portion of the above-mentioned front guide rail 28 is joined only to the above-mentioned guide rail support portion (upper hinge reinforcement 23) (see FIG. 3).

According to such a vehicle door structure, the lower portion of the front guide rail 28 has a cantilever structure and hence, when a vehicle-width-direction load is input with the door window glass 18 in a fully open state, it is possible to cause the front guide rail 28 to surely follow the door window glass 18.

In the correspondence between the configuration of the present disclosure and the above-described embodiment,
the door in the present disclosure corresponds to the door 10 (front door) in the embodiment,
likewise, hereinafter,
the window opening corresponds to the window opening 13,
the door window corresponds to the door window glass 18,
the door inner panel corresponds to the door inner panel 20,
the front face portion of the door inner panel corresponds to of the front face portion 20A of the door inner panel,
the guide rail support portion corresponds to the upper hinge reinforcement 23,
the first section corresponds to the first section 23A,
the second section corresponds to the second section 23B,
the third section corresponds to the third section 23C,
the front guide rail corresponds to the front guide rail 28,
the front face portion of the front guide rail corresponds to the front face portion 28a,
the inner-side face portion of the front guide rail corresponds to the inner-side face portion 28b,
the impact bar corresponds to the impact bar 41,
the door hinge fixation portion corresponds to the fixation portion of the door-side hinge bracket 51 of the door hinge bracket upper portion 21, and
the beltline corresponds to the beltline BL.

However, the present disclosure is not limited only to the configuration of the above-described embodiment, and many other embodiments may be realized.

For example, in the above-mentioned embodiment, the case in which the vehicle door structure is applied to the right front door of the vehicle has been described. However, the vehicle door structure of the present disclosure may be applied to the left front door and the left and right rear doors of the vehicle.

In the above-mentioned embodiment, the vehicle door structure is applied to a door structure including the door sash portion 12. However, the vehicle door structure may be adopted for a sash-less door structure.

### INDUSTRIAL APPLICABILITY

As described above, the present disclosure is effectively used for a vehicle door structure including a door inner panel that forms a surface of the vehicle door structure on a vehicle cabin inner side, a door window that opens and closes a window opening located above a beltline, a front guide rail that holds the door window while allowing a raising and lowering operation of the above-mentioned door window, and a guide rail support portion that fixes the above-mentioned front guide rail to the above-mentioned door inner panel.

1. A vehicle door structure, comprising:
a door inner panel that forms a surface of the vehicle door structure on a vehicle cabin inner side;
a door window that opens and closes a window opening located above a beltline;
a front guide rail that holds the door window while allowing a raising and lowering operation of the door window; and
a guide rail support portion that fixes the front guide rail to the door inner panel, wherein
the guide rail support portion includes
a first section that is fixed to a front face portion of the door inner panel,
a second section that extends rearward from a vehicle-width-direction inner side of the first section, and
a third section that is provided at a rear end portion of the second section and that is fixed to the front guide rail, and
the second section and the third section are configured to be supported in a cantilever manner with respect to the first section.

2. The vehicle door structure according to claim 1, wherein
the first section is located at a door hinge fixation portion.

3. The vehicle door structure according to claim 2, wherein
the third section is disposed in such a way as to overlap with an impact bar when viewed from a side of a vehicle.

4. The vehicle door structure according to claim 1, wherein
the third section is disposed in such a way as to overlap with an impact bar when viewed from a side of a vehicle.

5. The vehicle door structure according to claim 1, wherein
the third section is fixed to a front face portion of the front guide rail.

6. The vehicle door structure according to claim 1, wherein
the third section is fixed to an inner-side face portion or an outer-side face portion of the front guide rail.

7. The vehicle door structure according to claim 5, wherein
the third section is fixed to an inner-side face portion or an outer-side face portion of the front guide rail.

8. The vehicle door structure according to claim 1, wherein
the second section is configured to have a flat surface.

9. The vehicle door structure according to claim 1, wherein
a lower portion of the front guide rail is joined only to the guide rail support portion.

10. A vehicle door structure, comprising:
a door inner panel that forms a surface of the vehicle door structure on a vehicle cabin inner side;
a door window that opens and closes a window opening located above a beltline;
a front guide rail that holds the door window while allowing a raising and lowering operation of the door window; and
a guide rail support portion that fixes the front guide rail to the door inner panel, wherein
the guide rail support portion includes
a first section that is fixed to a front face portion of the door inner panel,
a second section that extends rearward from a vehicle-width-direction inner side of the first section, and
a third section that is provided at a rear end portion of the second section and that is fixed to the front guide rail, and
the second section is configured to be capable of being deflected and deformed in a vehicle width direction.

11. The vehicle door structure according to claim 10, wherein
the second section is configured to have a flat surface.

12. The vehicle door structure according to claim 10, wherein
a lower portion of the front guide rail is joined only to the guide rail support portion.
